(19) United States
(12) Patent Application Publication
(10) Pub. No.: US 2025/0388331 A1
(43) Pub. Date: Dec. 25, 2025

(54) MOTOR HEALTH MONITORING

(71) Applicant: BETA AIR, LLC, South Burlington, VT (US)

(72) Inventors: Tyler Arsenault, Cambridge, VT (US); Philip Butler, South Burlington, VT (US)

(21) Appl. No.: 18/752,186

(22) Filed: Jun. 24, 2024

(51) Int. Cl. B64D 31/16; B64C 29/00; H02P 21/14

(52) U.S. Cl. CPC B64D 31/16; H02P 21/141; B64C 29/0025

(57) ABSTRACT

An electrically powered aircraft is configured to check the health of its motors by determining a flux linkage associated with each of the motors. The flux linkage may be determined by measuring the back-EMF of stator coils of the motor. The flux linkage may be measured while the motor is not powered or may be estimated when the motor is in use. The flux linkage of a motor may be compared to a corresponding threshold value to assess whether the magnet(s) of the motor have degraded to a point at which they pose safety concerns. The flux linkage values may also be used to project when the motor needs to be maintained and/or replaced. The flux linkage value of a motor may be displayed, along with historical flux linkage values for that motor, to show a magnitude of demagnetization of the magnet(s) of the motor.

### TECHNICAL FIELD

The present disclosure relates to determining and monitoring the health of a motor. More specifically, the present disclosure relates to determining the health or strength of a magnet in a motor.

### BACKGROUND

In electrically propelled vehicles, such as an electric vertical takeoff and landing (eVTOL) aircraft, it is essential to maintain the integrity and safe operation of the components, such as motors, of the aircraft until safe landing. If one or more motors malfunction or operate in a less optimal state, the safety of the eVTOL, along with those onboard, may be compromised. In some cases, if the magnet in a permanent magnet motor degrades, the motor may not be able to provide sufficient torque during operation, resulting in performance degradation or even safety issues. For example, if the magnetic domains of a magnet of a motor are sufficiently depolarized over time, the motor may be incapable of providing sufficient torque when needed during flight, such as if the aircraft needs to climb quickly or speed up. It is thus desirable to be able to monitor the health of the motor and its constituent magnet(s).

### SUMMARY

In an aspect of the present disclosure, a motor controller includes one or more processors and one or more computer-readable media storing computer-executable instructions that, when executed by the one or more processors, cause the motor controller to determine a first current associated with a motor controlled by the motor controller. The computer-executable instructions, when executed by the one or more processors, further cause the motor controller to determine, based at least in part on the first current, a back-electromotive force (EMF) signal associated with the motor, determine, based at least in part on the back-EMF signal, a back-EMF magnitude and a back-EMF velocity, determine, based at least in part on the back-EMF magnitude and the back-EMF velocity, a first flux linkage value of the motor at a first time, and cause to report the first flux linkage value.

In another aspect of the present disclosure, a method includes determining, by a motor controller using one or more current sensors, a first current associated with a motor controlled by the motor controller, determining, by the motor controller using the one or more current sensors, a second current associated with the motor, and determining, based at least in part on the first current and second current, a back-electromotive force (EMF) signal associated with the motor. The method further includes determining, based at least in part on the back-EMF signal, a first flux linkage value of the motor at a first time and causing to store, in a datastore, the first flux linkage value associated with the first time.

In yet another aspect of the present disclosure, an aircraft includes one or more controller(s), a datastore, a motor, one or more current sensors communicatively coupled to the one or more controller(s), and a display device. The one or more controller(s) are configured to receive, from the one or more current sensors, a current value associated with the motor, determine, based at least in part on the current value, a back-electromotive force (EMF) value associated with the motor, and determine, based at least in part on the back-EMF value, a flux linkage value at a first time. The one or more controller(s) are configured to determine that the flux linkage value is greater than a threshold level, determine, based at least in part on the flux linkage value being greater than the threshold level, that the motor is safe to use, indicate, on the display device, that the motor is safe to use, and store the flux linkage value in association with the first time in the datastore.

### BRIEF DESCRIPTION OF DRAWINGS

FIG. 1 is a block diagram of an example electric vertical takeoff and landing (eVTOL) aircraft, according to examples of the disclosure.

FIG. 2 is a schematic illustration of an example motor assembly of the eVTOL aircraft of FIG. 1, according to examples of the disclosure.

FIG. 3 is a flow diagram depicting an example method to determine flux linkage of a motor using back-EMF data, according to examples of the disclosure.

FIG. 4 is a block diagram depicting an example method for monitoring the health of a motor of the eVTOL aircraft of FIG. 1, according to examples of the disclosure.

FIG. 5 is an example chart depicting the monitoring of the flux linkage of a motor of the eVTOL aircraft of FIG. 1 over time, according to examples of the disclosure.

FIG. 6 is a block diagram of a controller of inverter of the eVTOL aircraft of FIG. 1, according to examples of the disclosure.

### DETAILED DESCRIPTION

Wherever possible, the same reference numbers will be used throughout the drawings to refer to the same or like parts.

The disclosure herein is directed to systems, methods, and apparatus for monitoring the health of a motor and/or its constituent magnet(s). In examples of the disclosure, the motor may be in a vehicle, such as an aircraft, such as an electric vertical takeoff and landing (eVTOL) aircraft and/or in a conventional takeoff and landing (CTOL) aircraft. Although disclosed in the context of an eVTOL aircraft, it should be understood that the disclosure herein may be applied to any situation where a motor health and reliability is to be determined. For example, if one of a plurality of motors of an eVTOL aircraft were to be degraded, the disclosure herein allows for the motor to be monitored such that any degradation of the motor may not reduce the safety of the eVTOL aircraft. In examples, the motor and its constituent permanent magnet(s) may be monitored for flux linkage. The flux linkage, as used herein, relates to the interaction of the coils within the motor with the magnetic flux induced by the permanent magnet(s) of the motor.

According to the disclosure, a health of a motor may be determined and monitored to identify if any degradation of the magnet(s) of the motor are sufficiently large to pose a safety risk. The flux linkage of a magnet within a motor may be determined using back-EMF measurements, as determined by a back-EMF observer which determines the current back-EMF to estimate the position of the rotor relative to the stator within the motor. The back-EMF is related to the voltage induced in the coils of the motor while the motor is spinning with a magnetic field. In some cases, the back-EMF observer may be a standard component within an inverter that provides commutating power to the motor to enable position sensorless commutation to the motor. In other words, no additional hardware may be needed within the motor or the inverter to monitor the health of the motor, as disclosed herein. The flux linkage, at any given time, may be determined as the quotient of the magnitude of the back-EMF to the velocity of the back-EMF.

The flux linkage of a motor, as determined at any given time, may further be used to determine the health and/or remaining life of the magnet(s) of the motor. In some cases, the flux linkage may be displayed on a display device (e.g., a display screen) to be viewed, such as by a pilot or maintenance technician of the eVTOL aircraft. In other cases, the flux linkage may be displayed as a time series, showing its variation with time. In still other cases, the current flux linkage value may be compared to a corresponding threshold value to determine if the magnet strength has weakened to a point where there is a safety concern. In yet other cases, the time series trend of the flux linkage may be used to estimate the remaining usable lifetime of the motor and/or its constituent magnet(s). Such projections may inform maintenance schedules and/or safety inspections of the eVTOL aircraft. In still other cases, the flux linkage may be used to determine the actual strength of the magnet(s) of the motor, such as based on knowledge of the initial strength of the magnet(s) of the motor.

It should be understood that the mechanism disclosed herein may be utilized to measure the flux linkage of the motor when the motor is unpowered or may be utilized to estimate the flux linkage of the motor when the motor is power (e.g., when the eVTOL aircraft is in flight). In the case where the motor is unpowered, but spinning, the back-EMF may be determined using current measurements at the stator coils of the motor. The back-EMF may then be used to determine the flux linkage value of the motor. In the case where the motor is unpowered and not spinning, open loop or closed loop commutation may be used to spin up the motor, after which the motor is not provided any power. At that point, the motor is unpowered, but still spinning due to inertia of the load (e.g., a propeller) on the motor, and the back-EMF may be measured and used to determine a flux linkage value. In the case where the motor is powered, or in other words, commutation signals are being provided to the motor, the back-EMF may be estimated using current measurements and an electrical model of the motor.

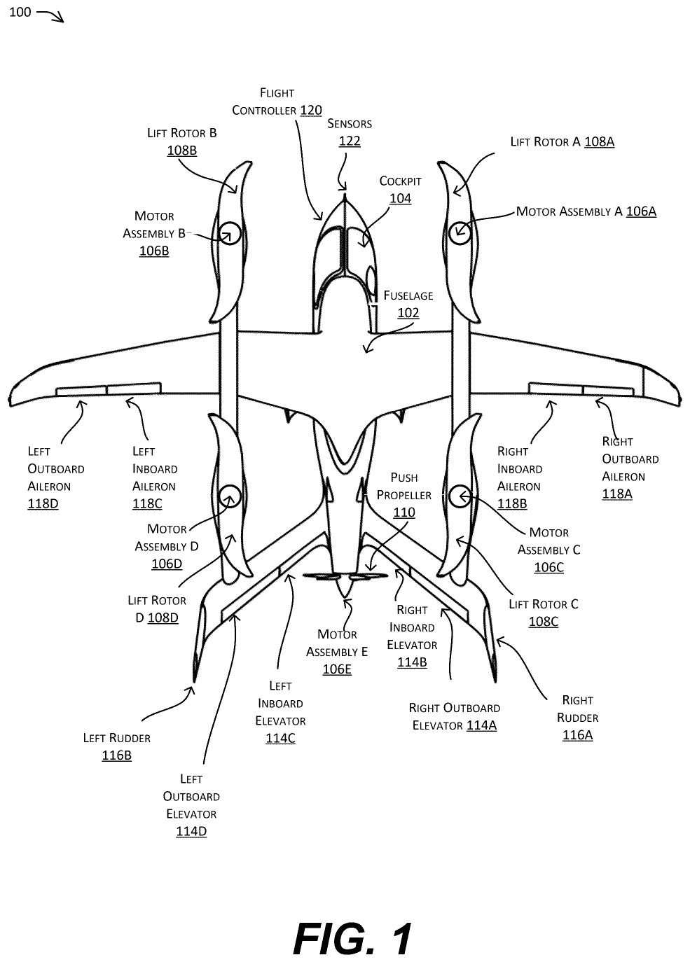

FIG. 1 is a block diagram of an example electric vertical takeoff and landing (eVTOL) aircraft 100, according to examples of the disclosure. The aircraft 100 includes a fuselage 102 and a cockpit 104 to carry passengers and/or a pilot. In alternate cases, the aircraft 100 may be unmanned and controlled remotely. In some cases, the aircraft 100 may have a fly-by-wire control system.

Although, discussed in the context of an eVTOL aircraft 100, it should be understood that the disclosure herein may be applied to any use case where the health of a motor, such as a permanent magnet synchronous motor (PMSM), is to be determined, monitored, and/or used to assess safety or maintenance concerns. Thus, the disclosure may be applied to any variety of transportation applications, such as electric watercrafts, electric cars, electric heavy machinery, electric trucks, electric trains, electric busses, or the like. The disclosure herein may also be applied outside of the realm of transportation, such as in appliances, power tools, or the like.

The aircraft 100 may include motor assembly A 106A, motor assembly B 106B, motor assembly C 106C, motor assembly D 106D, and motor assembly E 106E, hereinafter referred to in the singular as motor assembly 106 or in the plural as motor assemblies 106. The motor assemblies 106 may be positioned to balance thrust and/or lift distribution across the aircraft 100. In some embodiments, one or more of the motor assemblies 106 may be configured for redundancy or for failover purposes. For example, in some cases, if motor assembly A 106A were to fail and/or operate at a reduced capacity, a set of other motor assemblies (e.g., motor assembly B 106B, motor assembly C 106C, and/or motor assembly D 106D) may be configured to compensate for the reduced and/or lost operational capacity of motor assembly A 106A.

The motor assemblies 106 may be configured to drive (e.g., rotate) one or more propulsors, such as lift rotors 108A, 108B, 108C, 108D, hereinafter referred to in the singular as lift rotor 108 or in the plural as lift rotors 108, and/or a push propeller 110. For example, motor assembly A 106A may be configured to drive the lift rotor A 108A, motor assembly B 106B may be configured to drive the lift rotor B 108B, motor assembly C 106C may be configured to drive the lift rotor C 108C, motor assembly D 106D may be configured to drive the lift rotor D 108D, and motor assembly E 106E may be configured to drive the push propeller 110. In some examples, lift rotors 108 may be configured to enable the vertical takeoff of the aircraft 100, while the push propeller 110 may be configured to enable the horizontal movement of the aircraft.

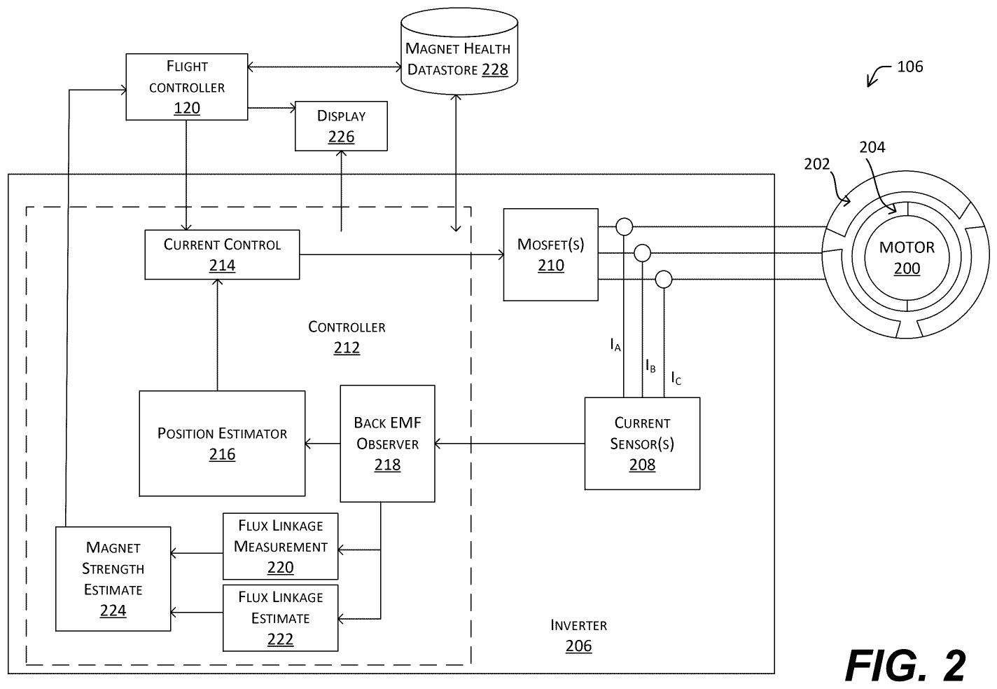

The motor assemblies 106 may include an electric motor and associated hardware and software to control the operation of the motor assemblies 106, as will be discussed in conjunction with FIG. 2. The aircraft 100 may include one or more energy sources such as one or more batteries (not shown) to store electric energy that is used to energize the motor assemblies 106 to drive their corresponding lift rotors 108 and/or push propeller(s) 110. For example, a battery may store electrical energy and provide that energy, as controlled by the components of the motor assembly 106 to provide direct current (DC) electric power to power motors of the motor assemblies 106 to rotate the corresponding lift rotors 108 and/or push propeller 110. The motor assemblies 106 may operate at any suitable voltage, current, and/or power. For example, the motor assemblies may operate in a voltage range of about 25 volts to about 500 volts and a current range of about 10 Amps to about 100 Amps. In some cases, the operating voltage range of about 50 volts to about 300 volts and a current range of about 20 Amps to about 40 Amps. An inverter, as discussed further in conjunction with FIG. 2, may convert the DC electric power stored by a battery into alternating current (AC) power and/or pulse width modulated (PWM) power and provide the AC and/or PWM power to the motors in each of the motor assemblies 106 as commutation signals.

The aircraft 100 includes a set of control surfaces, such as a right outboard elevator 114A, right inboard elevator 114B, left inboard elevator 114C, and left out board elevator 114D, hereinafter referred to in the singular as elevator 114 or in the plural as elevators 114. The elevators 114 are configured to control the pitch of the aircraft 100. In some cases, the elevators 114 on both sides of the aircraft 100 may be partitioned into two or more components to provide more precise control over the pitch of the aircraft 100 and/or to provide redundancy in the event of any component failure. For example, in some embodiments, having two or more elevators 114 on each side enables independently controlling those elevators 114 to enable more fine-tuned control over the pitch of the aircraft 100. Additionally, in the event of failure of a first elevator 114 on one side, a second elevator 114 on the same side may enable control of the pitch of the aircraft 100 on that side to mitigate the effects of the failure.

Additional control surfaces of the aircraft 100 include a right rudder 116A and left rudder 116B, hereinafter referred to in the singular as rudder 116 or in the plural as rudders 116, to control yaw of the aircraft 100. Although, unlike the elevators 114, the rudders 116 of the aircraft 100 are not depicted as partitioned on two sides it should be understood that in some airframe embodiments, the rudders 116 of the aircraft 100 may be partitioned on one or both sides. Still further, the aircraft 100 may include a right outboard aileron 118A, a right inboard aileron 118B, a left inboard aileron 118C, and a left outboard aileron 118D, hereinafter referred to in the singular as aileron 118 or in the plural as ailerons 118, to generate lift or drag. Any of the control surfaces 114, 116, 118 may be of more or less numbers and may be controlled by a pilot, a remote operator, or a bot, either directly or indirectly (e.g., fly-by-wire). Each of the control surfaces 114, 116, 118 may be controlled using one or more actuators (not shown).

As further depicted in FIG. 1, the aircraft 100 includes a flight controller 120. The flight controller 120 may include one or more flight controller components (e.g., one or more flight control computers (FCCs)) configured to generate command signal(s) that control the operation of various components of the aircraft 100. For example, the flight controller unit 120 may be configured to generate command signal(s) that control the operation of one or more inverters that provides electrical power and/or commutation within the motor assemblies 106 of the aircraft 100, an actuator that controls the operation of at least one control surface 114, 116, 118 of the aircraft 100, and/or the like.

A pilot (not shown) or other operator of the aircraft 100 may be in the cockpit 104 of the aircraft 100 to control the operation (e.g., speed, direction, altitude, etc.) of the aircraft 100. The pilot may interact with a variety of control devices (not shown) within the cockpit 104 to control the actions of the aircraft 100. The control devices may be configured to detect a pilot action and transmit pilot input data representing a desired action of the aircraft 100 (e.g., an electrical signal encoding the detected desired action) to the flight controller 120. A pilot control device may include a throttle lever, an inceptor stick, a lift lever, a steering wheel, a brake pedal, a pedal control, a toggle, a joystick, a collective pitch control device, an alpha-numeric input device (e.g., a keyboard), a pointing device, an audio input device (e.g., a microphone, a voice response system, etc.), a cursor control device (e.g., a mouse), a touchpad, an optical scanner, a video capture device, a touchscreen, and/or the like.

The flight controller 120 may identify inputs from the pilot and/or remote operator via one or more control devices and use those inputs to control various components of the aircraft 100. The aircraft 100 may perform the actions desired by the pilot and/or remote operator by way of commands generated by the flight controller 120 to move control surfaces 114, 116, 118 and/or control the motor assemblies 106. In some cases, the flight controller 120 may also receive signals from sensor(s) 122. The sensors 122 may provide a variety of information to the controller 120, such as location (e.g., latitude, longitude, altitude, etc.), obstructions, temperature, humidity, other environmental factors, etc. The flight controller 120 may be configured to change the operation of the aircraft 100 responsive to signals from the sensors 122.

The flight controller 120 may include a microprocessor, a digital signal processor (DSP), a system on a chip (SoC), a field-programmable gate array (FPGA), a complex programmable logic device (CPLD), an application specific integrated circuit (ASIC), a multi-chip module, a printed circuit board, and/or the like. In some embodiments, the flight controller 120 is configured to receive one or more pilot input signals from one or more pilot control devices, perform one or more signal processing operations (e.g., one or more time-frequency analysis operations) on the pilot control signal(s) to generate one or more transformed signals, and determine the pilot command signal based on the transformed signal(s). In some examples, the flight controller 120 may use one or more trained machine learning models to perform the signal processing operation(s) on pilot control signal(s) and/or sensor signal(s) to generate commands for various components of aircraft 100.

As described above, in some cases, the flight controller unit 120 may determine one or more command signals for controlling the aircraft 100 and/or a trajectory generated for the aircraft 100 based on sensor data provided by the sensor(s) 122. The sensor(s) 122 may include vision sensor(s), depth sensor(s) (e.g., LiDAR sensor(s)), torque sensor(s), gyroscope(s), accelerometer(s), magnetometer(s), inertial measurement unit(s) (IMU(s)), pressure sensor(s), force sensor(s), proximity sensor(s), displacement sensor(s), vibration sensor(s), environmental sensor(s), and/or the like.

The flight controller 120 may further be configured to provide a variety of control signals to the motor assemblies 106 to control their respective lift rotors 108 and/or push propellers 110. For example, the flight controller 120 may cooperate with one or more controllers of the motor assemblies 106 to provide an enable signal to enable the operation (e.g., active powered operation) of the motor assemblies 106.

The motor assemblies 106, as disclosed herein, may be configured to operate in a synchronized or closed loop manner, where the position of the motor is used as feedback to provide control signals (e.g., commutation signals) to the various phases of the motor. The motor assemblies 106 may also be configured to operate in an open loop manner, without position feedback. In open loop operation, the motor is only controlled using the commutation signals, without the benefit of positional feedback from the motor. When the motor is not powered, but still spinning, a back-electromotive force (EMF) is generated. The back-EMF is generally proportional to the angular velocity of the motor.

Put another way, when commutation of a motor is interrupted for any reason, the motor, while spinning, will still produce a back-EMF opposing the motion of the motor.

It should be understood that the motor assemblies 106 may not include a position sensor. The control mechanisms and related control laws may not use a position sensor for synchronization of the motor assembly 106. Instead, the motor assembly, and the synchronization thereof, may be controlled using back-EMF and/or current and/or voltage measurements at the various phases of the motor assembly 106. The position of the motor, as used herein, refers to the position of the rotor of the motor relative to the stator. It should be understood that the position of the motor may be referred to by any other suitable terms, such as rotor position, motor angle, rotor angle, motor phase, rotor phase, or the like.

It should be appreciated that the motor in the motor assemblies 106 may degrade over time, leading to potential safety issues. Permanent magnet(s), such as magnet(s) disposed in the rotor or the stator of the motor may degrade over time, as the magnet(s) are exposed to other magnetic fields and/or high temperatures of operation. For example, even under the Currie temperature, if a permanent magnet is held at a relatively high temperature, the magnetic domains of the permanent magnet may depolarize over time. As permanent magnet(s) of a motor weaken, the maximum available torque output of the motor may also degrade. At some point, the permanent magnet(s) of a motor may degrade to a level where the degradation in performance may be a safety concern.

According to examples of the disclosure, a motor assembly 106 may be configured to assess the health of one or more permanent magnets of its motor. The back-EMF may be determined, such as by measuring the current through the coils of the motor. The back-EMF may then be used to determine the rotational velocity of the motor. For example, depending on the configuration of the motor, the periodicity of the back-EMF signal may be equal to, or a multiple of, the periodicity of the rotating motor. Additionally, the magnitude of the back-EMF may be determined. In some cases, the flux linkage of the motor may be determined based at least in part on the rotational velocity and the magnitude of the back-EMF. For example, the flux linkage may be determined as the rotational velocity divided by the magnitude of the back-EMF.

The flux linkage of the motor may be logged (e.g., stored in a datastore) and/or displayed (e.g., on a display device or printer). The flux linkage may also be compared to past flux linkage values for the motor. For example, flux linkage values from the past may be accessed from a datastore with those past flux linkage values and corresponding timestamps. Plotting the current and past flux linkage values for a motor may indicate how its flux linkage value has changed over time. Such trends over time may be used to predict future maintenance and/or replacement schedules for the motor and/or the permanent magnets therein.

The flux linkage values, as determined from back-EMF data of the motor, may be compared to a corresponding threshold value. If a flux linkage value, or alternatively a series of values, are below the threshold value, then it may be determined that the motor is either unsafe for its application and/or that the motor is to be serviced. On the other hand, if the flux linkage value is greater than the threshold value, then the motor may be safe to use for its application (e.g., eVTOL aircraft 100). If it is determined, based at least in part on the comparison of the flux linkage value to the threshold value, that the motor is either unsafe for its application and/or the motor is to be serviced, then the same may be indicated to a pilot or other operator of the eVTOL aircraft 100.

Although discussed in the context of the eVTOL aircraft 100, it should be understood that the apparatus, systems, and methods disclosed herein to monitor the health of the motors assemblies 106 may be applied to any suitable application. For example, the mechanism for monitoring the health of the motors may be applied to a conventional takeoff and landing (CTOL) aircraft or other transportation vehicles. The CTOL may include one or more propulsion motors located in the front, rear, or along the wings of the aircraft that may need health monitoring using the mechanisms disclosed herein.

FIG. 2 is a schematic illustration of an example motor assembly 106 of the eVTOL aircraft 100 of FIG. 1, according to examples of the disclosure. The motor assembly 106 may include a motor 200. The motor 200 may be the component that provides rotational motion from the motor assembly 106 for any variety of purposes, such as to rotate the lift rotors 108 and/or the push propellers 110. The motor 200 may be of any suitable type, such as a permanent magnet synchronous motor (PMSM). Alternatively, the motor 200 may be any suitable DC or AC motor, such as brushed, brushless, synchronous, induction, switched-reluctance, or the like. The motor 200 may have any suitable topology and/or number of phases. For example, the motor 200 may have three phases that are separated by 120° (2π/3 radians). Alternatively, the motor may have six phases that are separated by 60° (π/3 radians). Indeed, the motor 200 may have any suitable number of phases, split-phases, or the like.

As shown, the motor 200 may include a stator 202 with coils that energize in a rotating fashion to rotate a permanent magnet 204, which can also be referred to as the rotor. Although depicted with a single permanent magnet 204, it will be understood that there may be any suitable number of permanent magnets 204, with any suitable number of magnetic poles, within the motor 200. As the motor 200 ages, the permanent magnet 204 may degrade in strength. The degradation may be a result of depolarization of magnetic domain of the materials of the permanent magnet 204, such as due to exposure to high temperatures or other magnetic fields, such as those induced by the stator 202. The permanent magnet 204 may be of any suitable type and/or material of construct, such as neodymium magnets, samarium cobalt magnets, alnico magnets, and/or ferrite magnets.

The motor assembly 106 includes an inverter 206 that provides power to the motor 200. The inverter 206 may include hardware and software that cooperate to provide power to the motor 200 as commutation signals. Commutation signals, as used herein, refer to signals that provide both timing and power to the motor 200 to enable the motor 200 to rotate, such as to cause the permanent magnet 204 to rotate relative to the stator 202. The inverter 206 may include switched power electronics, such as metal-oxide-semiconductor field effect transistors (MOSFETs) 210 or other transistors or switches. The MOSFETs 210 may be arranged as various legs (not shown) of the inverter 206, where each leg provides commutation signals to each phase of the stators 202 of the motor 200. In other words, the MOSFETs 210 may be switched in such a manner as to energize the phases of the motor 200 in succession to rotate the permanent magnet 204 of the motor 200. The commutation signals from the MOSFETs 210 may be in any suitable form, such as pulse width modulated (PWM).

The inverter 206 may include current sensor(s) 208. The current sensor(s) 208 may also be referred to as current meters and are configured to measure the current (IA, I_{B}, and I_{C}) provided to each of the phases (A, B, and C) of the motor 200. The current sensor(s) 208 may provide the current (I_{A}, I_{B}, and I_{C}) measurements as a series of values with time. Although a three-phase motor 200 is discussed here, it should be understood that motor 200 may be of any suitable number of phases. The number of phase currents measured may depend on the number of phases of the motor 200.

In some alternate cases, the inverter 206 may also include voltage sensor(s) (not shown), in addition to the current sensor(s) 208. The voltage sensor(s) may also be referred to as voltage meters and are configured to measure the voltage (V_{A}, V_{B}, and V_{C}) at each of the phases (A, B, and C) of the motor 200. The voltage sensor(s) 208 may provide the voltage (V_{A}, V_{B}, and V_{C}) measurements as a series of values with time. The voltage measurements may be used, in alternative examples, to supplement the current measurements in determining the back-EMF values of the motor 200 during use.

The inverter 206 may further include an inverter controller 212, also referred to as motor controller 212 or controller 212, that provides the timing and current control 214 to the MOSFETs 210 of the inverter 206. Thus, it is the controller 212 that enables the inverter 206 and the motor assembly 106 to operate in a closed loop operation, using feedback, such as timing feedback, in controlling the motor 200. The controller 212 may determine the motor position via a position estimator 216 function within the controller 212. The functionality of the position estimator 216 may rely on a back-EMF observer 218 functionality within the controller 212. The back-EMF observer 218 may determine the back-EMF from the motor 200 based at least in part on the current measurements received from the current sensors 208. The back-EMF observer 218 in cooperation with the position estimator 216 allows for the estimate of the position of the motor 200.

The controller 212 uses, at least in part, the position estimate from the position estimator 216 to provide current control 214 to the MOSFETs 210 to commutate the motor 200. For example, the controller 212 may determine, from the motor position estimate, when the second phase is to be deenergized and the third phase is to be energized. Then the controller 212 may generate the corresponding current control 214 signals to deenergize the second phase and energize the third phase of the motor 200. Continuing further with this example, the current control 214 provided to the MOSFETs 210 may cause the MOSFETs 210 to shunt a stator coil of the motor 200 corresponding to the second phase to ground and shunt a stator coil of the motor 200 corresponding to the third phase to a current or power source. In this way, the controller 212 provides current control 214 to the MOSFETs 210 to selectively energize and deenergize the phase coils of the motor 200 in a rotating manner to physically rotate the permanent magnet 204 of the motor 200. The control signals 212 may be provided to the gates (e.g., the control terminal) of the MOSFETs 210 in a selective and synchronized manner to turn on or off individual ones of the MOSFETs 210. It should be understood that switches, other than MOSFETs 210, may be used to power the motor 200 and be similarly controlled by the inverter controller 212. For example, switches such as insulated gate field effect transistors (IGFETs), bipolar junction transistors (BJTs), or the like may be used in place of, or in conjunction with, the MOSFETs 210.

During normal synchronized operation, the controller 212 operates the motor in a closed loop operation, where feedback from the motor 200 is used to control the motor 200. Closed loop operation, making use of feedback and position estimates, is a more robust form of motor 200 control than open loop operation, where feedback is not used for motor 200 control. The inverter 206 provides commutation to the motor 200 using the position estimation. Closed loop operation of the motor 200 may further depend, at least in part, on commands received from the flight controller 120. For example, the flight controller 120 may instruct the inverter 206 to speed up the motor 200 or increase a torque generated by the motor. In this case, the controller 212 may speed up the motor 200, such as by increasing the frequency of commutation of the motor 200. Similarly, the controller 212 may be able to slow down the motor 200 or reduce a torque generated by the motor based at least in part on command(s) received from the flight controller 120.

Over time, the magnet 204 of the motor 200 may lose its magnetic strength. In other words, the magnet 204 may provide a weaker magnetic field over time. According to examples of the disclosure, the health of the magnet 204 and the motor 200 may be monitored over time to indicate when the motor 200 is no longer able to provide necessary peak torque that may be required for the eVTOL aircraft 100 or other applications of the motor 200. The flux linkage value may also be used for a variety of other

The controller 212 may include a function for flux linkage measurement 220, where the magnitude and velocity of the back-EMF may be determined and/or received from the back-EMF observer 218. At this point, the back-EMF magnitude and velocity may be determined according to the following equation:

$$Flux Linkage = ( Magnitude of back - EMF / Velocity of back - EMF ) \qquad Equation 1$$

Where the Magnitude of the back-EMF may be determined as the amplitude of the back-EMF generated by the motor 200 and the velocity of the back-EMF may be the rotational velocity of the back-EMF.

The controller 212 may use the function of flux linkage measurement 220 when the motor is not powered, but is still spinning. For example, the motor may be powered and spinning and when the power to the motor is turned off, the back-EMF therefrom may be determined by the back-EMF observer 218 using current measurements of the stator coils. In other words, a direct measurement of the back-EMF, and therefore the back-EMF magnitude/amplitude (e.g., in volts) and/or back-EMF velocity (e.g., in radians/second, degrees/second, Hertz, etc.) may be made when the permanent magnet 204 is rotating within the motor 200 at a sufficient speed and without being powered. In these cases, the motor 200 was powered recently enough that inertia of the motor 200 and/or any loads attached to the motor 200 (e.g., a propeller 108, 110) causes the permanent magnet 204, as the rotor of the motor 200, to spin at a sufficiently high speed to enable accurate and precise back-EMF measurements, and therefore accurate and precise flux linkage measurements.

In some cases, the motor 200 may be unpowered long enough for the motor 200 to stop rotating or to rotate below a threshold rotational speed. In these cases, the back-EMF from the motor 200 may be insufficient to accurately and/or precisely measure the back-EMF and/or the flux linkage. Therefore, if the motor 200 rotates below a threshold rotational speed, then the motor 200 may first be spun up and/or sped up prior to measuring the back-EMF to determine, using the flux linkage measurement 220, the current flux linkage value of the motor 200. In this case, the motor 200 may initially be operated in an open loop fashion, where the current control 214 from the controller 212 is not based on the real-time position of the motor 200. Rather, the motor 200 is accelerated without considering feedback or without the benefit of the position estimation. Once the motor 200 reaches a threshold velocity in open loop operation, open loop operation of the motor 200 may be terminated. After open loop acceleration, the aforementioned processes of measuring the back-EMF and using Equation 1, by the back-EMF observer 218 and the flux linkage measurement 220 function of the controller 212, to determine the current flux linkage of the motor 200. In some cases, the threshold rotational speed may be greater than about 20 RPM. In other cases, the threshold rotational speed may be greater than about 50 RMP. In one example, the threshold rotational speed may be about 69 RPM. If the motor is spinning at a speed under the threshold rotational speed, the back-EMF measurements and/or the flux linkage measured therefrom may lack precision and/or accuracy.

In the case where the motor 200 is powered, a flux linkage estimate 222 function of the controller 212 may be used to estimate the flux linkage of the motor 200. The estimate of the flux linkage may still use timing data from the back-EMF observer 218 and use an electrical model, such as a resistive-inductive (RL) circuit model, of the motor 200, to estimate the flux linkage of the motor 200 while the motor may be powered. The estimate of the flux linkage (while motor 200 is powered) may not be as accurate as the measurement of the flux linkage (while the motor 200 is unpowered), but may allow for more flux linkage data points, particularly while the motor 200 is in use. In some cases, Hopkinson's Law may be used to estimate the flux linkage of the motor 200.

According to examples of the disclosure, once the controller 212 determines the flux linkage at any given time, that flux linkage value may be optionally used to determine a magnet strength estimate using a magnet strength estimate 224 function of the controller 214. In other cases, only the flux linkage values may be used for safety assessments, and the magnet strength itself may not be estimated by the controller 212. If the magnet strength is estimated, the initial strength of the permanent magnet 204 may be used as a baseline along with the initial flux linkage value measurement or estimate when the motor 200 was new.

The current magnet strength may be determined based at least in part on the original permanent magnet 204 strength and a comparison between the original flux linkage values of the new motor 200 and the current flux linkage values. As a non-limiting example, if a flux linkage value is 5% below the flux linkage value when the motor 200 was new, then that may imply that the permanent magnet 204 strength may have also degraded by about 5%. As another non-limiting example, consider that a new permanent magnet 204 has a strength of 2 Tesla (20,000 Gauss). After some time, the flux linkage, as measured using the techniques disclosed herein, is 4% below when the permanent magnet 204 and the motor 200 were new, then the current permanent magnet strength may be 4% less than when the motor 200 was new, or 1.92 Tesla (19,200 Gauss). It should be understood that while a linear and direct relationship between the flux linkage and magnet strength was assumed in the preceding examples, in other cases, the flux linkage and the magnet strength may be related according to any suitable function (e.g., logarithm, quadratic, etc.).

In some cases, the magnet strength estimate may be provided by the controller 212 to the flight controller 120. The flight controller 120 and/or the inverter controller 121 may display the permanent magnet 204 strength and/or current flux linkage on a display device 226 and/or store the permanent magnet strength value and/or current flux linkage value associated with a timestamp in a magnet health datastore 228, to be accessed later. For example, the flux linkage data and/or the magnet strength estimate data, as stored in the magnet health datastore 228, may be accessed by either the flight controller 120 and/or the inverter controller 212 to generate a time series plot of the either set of data, such as to display on the display device 226.

The flight controller 120 and/or the inverter controller 212 may also provide a warning when the permanent magnet 204 estimated strength and/or flux linkage drops to levels that may pose or be close to posing a safety concern. In other words, the flight controller 120 and/or controller 120 may be configured to compare either a current magnet strength estimate and/or a current flux linkage value to a corresponding threshold value to ascertain whether the motor 200 may be unsafe for its intended application and/or in need of maintenance. If the motor 200, and its constituent permanent magnet 204, has degraded to a point where the degradation may pose a safety concern, the flight controller 120 and/or the inverter controller 212 may be configured to provide a warning to the pilot, maintenance personnel, or other user of the eVTOL aircraft 100 via any suitable human-machine interface, such as display device 226. Alternatively or additionally, the flight controller 120 and/or the inverter controller 212 may further be configured to send, via any suitable medium (e.g., Internet, Bluetooth, WiFi direct, etc.), a warning to a remote device, such as a maintenance technician's smartphone.

Historical motor health data (e.g., magnet strength estimates and/or flux linkage data) may further be used to project when the motor is to be serviced and/or maintained. By measuring this data, a more accurate maintenance timeline may be generated than just using motor age, usage hours, or other non-motor specific measures. For example, an eVTOL aircraft 100 used in Alaska, in relatively colder temperatures, may have a reduced level of motor degradation with time, while an eVTOL aircraft 100 used in Arizona, in relatively hotter temperatures, may have an accelerated degradation of its motor(s) 200. Thus, by using the techniques disclosed herein, to assess the current health of the motor 200, one can prevent maintenance and/or replacement of motors 200 prematurely or not frequently enough. Rather, the techniques disclosed herein enables servicing and/or replacement of the motor 200 commensurate with the motor's actual and measured usable state. Accordingly, the techniques disclosed herein enables full usage of a motor throughout its safe lifetime, without risk of using the motor 200 when it is no longer safe to do so.

The process of checking and logging the motor 200 health may further involve one or more control signals between the flight controller 120 and the inverter controller 212 or within either of the flight controller 120 and/or the inverter controller 212. For example, the flight controller 120 may provide a control signal to command the inverter controller 212 to determine the current flux linkage. The inverter controller 212 may provide acknowledgement messages and/or status messages to the flight controller 120. The inverter controller 212 may have one or more internal control signals and/or activating/trigger signals for timing the collection of the flux linkage and/or magnet strength estimate data.

It should be understood that the disclosure herein enables continuous and/or periodic assessment of the health of the motor(s) 200 of the eVTOL aircraft 100 or any other suitable application. The apparatus, systems, and methods disclosed allow for greater reliability and safety of aircrafts, such as electric aircrafts 100. The disclosure allows full usage of motors 200 without wasting any of its usable lifetime, resulting in financial and environmental benefits, without exceeding the motors' true, as measured lifetimes, resulting in safety benefits.

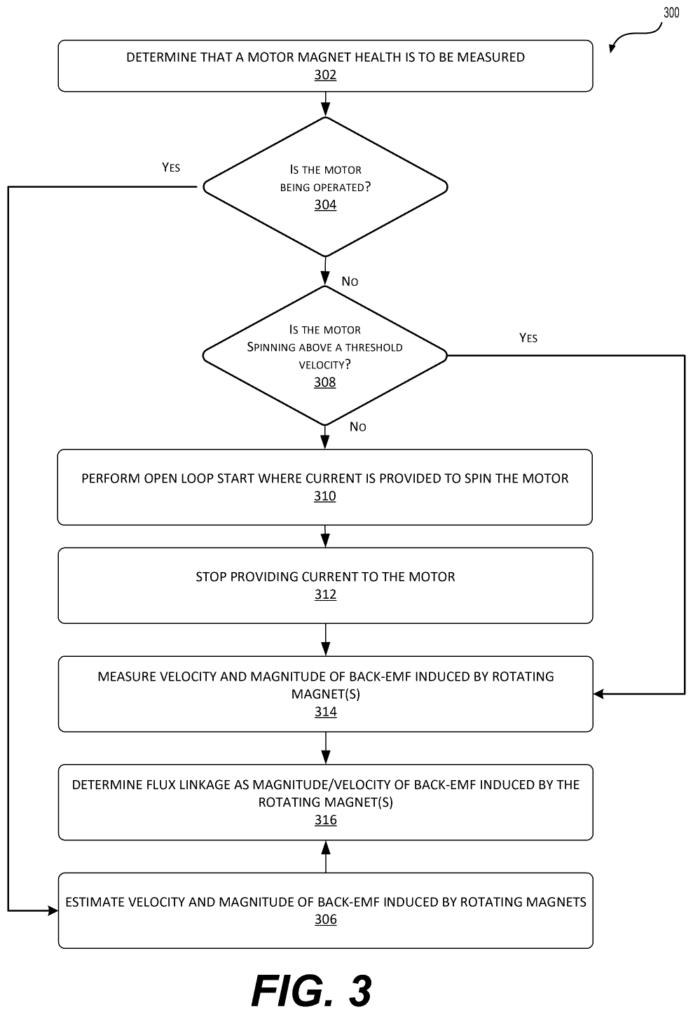

FIG. 3 is a flow diagram depicting an example method 300 for determining a flux linkage of a motor 200 using back-EMF data, according to examples of the disclosure. The processes of method 300 may be performed by the controller 212, individually or in conjunction with one or more other elements of the inverter 206, such flight controller 120. Method 300 allows the controller 212, individually or in cooperation with controller 120, to monitor the health of one or more motors 200. According to examples of the disclosure, method 300 may be performed while the aircraft 100 is unused or when the aircraft 100 is in flight. While the operations of method 300 are attributed to the inverter controller 212, it should be understood that any of the disclosed operations may be performed by the flight controller 120 or any other suitable controller.

At block 302, the controller 212 may determine that a motor 200 magnet 204 health is to be measured. The controller 212 may measure the magnet 204 health on a continuous and/or regular basis. Thus, the controller 212 may use an internal clock to time and periodically make measurements for assessing motor health. In some cases, the controller 212 may receive a control signal from flight controller 120 to take a measurement of the motor health at that time. In other cases, the controller 212 may measure the motor health just prior to or just after usage of the motor 200. For example, before the eVTOL aircraft 100 takes flight, the controller 212 and/or flight controller 120 may prompt a measurement of back-EMF and flux linkage of the motor 200. As a similar example, after the eVTOL aircraft 100 takes lands after a flight, the controller 212 and/or flight controller 120 may prompt a measurement of back-EMF and flux linkage of the motor 200.

At block 304, the controller 212 may determine whether the motor is being operated. The controller 212 if providing commutation signals from the MOSFETs 210 to the motor 200, then the motor 200 is in use. If the motor is in use, then the method 300 may proceed to block 306, where the velocity and magnitude of the back-EMF may be estimated based on current measurement(s) and/or an electrical model of the motor 200. The estimate of the flux linkage may still use timing data from the back-EMF observer 218 and use an electrical model (e.g., transfer function), such as an RL circuit model and/or RLC circuit model of the motor 200, to estimate the flux linkage of the motor 200 while the motor may be powered. The estimate of the flux linkage (while motor 200 is powered) may not be as accurate as the measurement of the flux linkage (while the motor 200 is unpowered), but may allow for more flux linkage data points, particularly while the motor 200 is in use. In alternate cases, the inverter 206 may temporarily stop providing commutation signals to the motor 200 to measure the flux linkage and then reengage power to the motor 200 after the flux linkage measurement is made. If the motor 200 is not in use, as determined at block 304, then the method 300 may proceed to block 308.

At block 308, after determining that the motor is not currently being operated, the controller 212 may determine whether the motor is currently spinning above a threshold speed. In some cases, the motor rotational speed may be equal to the frequency of the measured phase current, as measured by current sensor(s) 208 of the motor 200. For example, if a phase current, measured as a series of measurement values, indicates a frequency of 1 kilohertz (kHz), then the motor 200 may also be spinning with a rotational speed of 1 kHz. In other cases, the motor 200 may have a speed that is a multiple of the phase current and/or back-EMF measurements. The determined motor speed may be compared to a threshold value to determine if the back-EMF of the motor 200 can reliably be measured, with a desired level of accuracy and/or precision. If the motor speed is greater than the threshold speed value, then the method 400 may proceed to block 314. Otherwise, the method 300 may proceed to block 310.

At block 310, where the motor 200 is not being operated, but is either not spinning or not spinning fast enough to make a reliable back-EMF measurement, the controller 212 may perform an open loop start, where current is provided to spin up the motor 200. Open loop operation of the motor 200 is less reliable than closed loop operation of the motor 200, as back-EMF observation is not used to control commutation of the motor 200. However, open loop operation can allow for the inverter 206 to increase the speed of the motor 200 to beyond the threshold speed that allows for reliable determination of the back-EMF. Therefore, the inverter controller 212 generates open loop current control 214 for the MOSFETs 210, which in turn provide commutation signals to the motor 200 to operate in open loop and speed up beyond the threshold speed at which reliable motor back-EMF measurements may be made. In some cases, the threshold rotational speed may be greater than about 20 RPM. In other cases, the threshold rotational speed may be greater than about 50 RMP. In one example, the threshold rotational speed may be about 69 RPM. If the motor is spinning at a speed under the threshold rotational speed, the back-EMF measurements and/or the flux linkage measured therefrom may lack precision and/or accuracy. Alternatively, a closed loop start may be used instead of an open loop start to speed up the motor 200 beyond the threshold minimum speed.

At block 312, the controller 212 may stop providing current to the motor. The open loop current (e.g., power to the motor 200), or commutation signals, may be stopped when the motor 200 is spinning above the threshold speed. In some cases, the motor 200 may be spun up to greater than the threshold speed to compensate for any slow-down after the motor 200 is no longer powered, but before the back-EMF measurements are completed.

At block 314, where the motor 200 is not being operated (e.g., unpowered) and the motor 200 is spinning above the threshold velocity, the controller 212 may determine the velocity and the magnitude of the back-EMF induced by the rotating permanent magnet(s) 204. The back-EMF is related to the voltage induced in the coils of the motor 200 while the permanent magnet 204 is spinning. In some cases, the back-EMF observer 218 may be a standard component within the inverter 206 that provides commutating power to the motor 200 to enable position sensorless commutation to the motor 200. In other words, no additional hardware may be needed within the motor 200 or the inverter 206 to monitor the health of the motor 200, as disclosed herein. The back-EMF observer 218 may determine the back-EMF from the motor 200 based at least in part on the current measurements received from the current sensors 208. In some case, the phase current(s) of the motor 200 may be observed over one or more periods to determine the back-EMF of the motor 200.

At block 316, the controller 212 may determine the flux linkage based at least in part on the magnitude of the back-EMF and the velocity of the back-EMF induced by the rotating permanent magnet(s) 204 of the motor 200. Regardless of whether the back-EMF is measured while the motor is unpowered (block 314) or the back-EMF is estimated while the motor is powered (block 306), the magnitude and/or the velocity of the back-EMF may be used to determine the flux linkage of the motor 200. In some cases, the flux linkage of the motor 200 may be determined according to Equation 1.

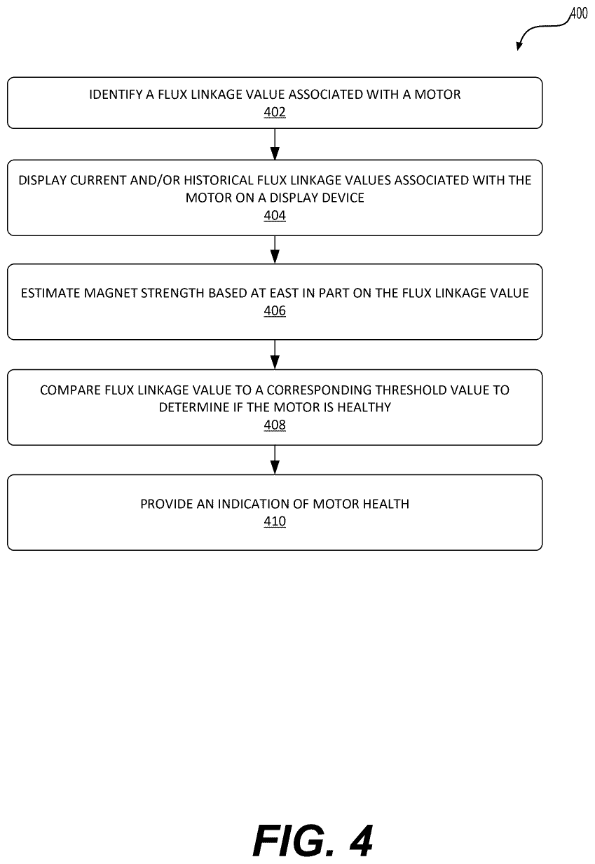

As disclosed herein, the method 300 enables the determination of the flux linkage of the motor 200 by using back-EMF of the motor 200, as determined using current measurements from the one or more current sensor(s) 208. The flux linkage of the motor 200 can then be used for a variety of analysis and assessments about the health of the motor 200, as further discussed in conjunction with FIG. 4.

It should be noted that some of the operations of method 300 may be performed out of the order presented, with additional elements, and/or without some elements. Some of the operations of method 300 may further take place substantially concurrently and, therefore, may conclude in an order different from the order of operations shown above.

FIG. 4 is a block diagram depicting an example method 400 for monitoring the health of a motor 200 of the eVTOL aircraft 100 of FIG. 1, according to examples of the disclosure. The processes of method 400 may be performed by the controller 212, individually or in conjunction with one or more other elements of the inverter 206, such as flight controller 120. Method 400 allows the controller 212 and/or flight controller or other controller to assess, monitor, and/or report the health of the motor 200. According to examples of the disclosure, operations of method 400 may be performed while the aircraft 100 is in flight.

At block 402, the controller 212 and/or controller 120 may identify a flux linkage value associated with a motor 200. In examples, the motor 200 may be a part of the eVTOL aircraft 100. The flux linkage value for the motor 200 may be determined, in some examples, by the operations of method 300 of FIG. 3. As disclosed herein, the motor 200 may have any suitable flux linkage value. In some cases, the flux linkage value may be in the range of about 0.02 Webber (Wb) to about 3 Wb. In other cases, the flux linkage value may be in the range of about 0.05 Wb to about 1 Wb. As disclosed herein, the flux linkage value may be determined based at least in part on measurement of the back-EMF of the corresponding motor 200, as determined from one or more current measurements, such as current measurements over time and/or current measurements of different phases of the motor 200.

At block 404, the controller 212 and/or flight controller 120 may display the current and/or historical flux linkage values associated with the motor 200 on a display device 226. The historical flux linkage values may be accessed from the motor health datastore 228. In some cases, the flux linkage data, as a time series, may be displayed on a display device 226 to be viewed, such as by a pilot or maintenance technician of the eVTOL aircraft 100. Such a display may help an operator of the eVTOL aircraft 100 to identify any issues, such as accelerated magnet degradation of the motor(s). The time series of flux linkage data may be displayed for multiple motor(s) 200, such as for each of the motors 200 of the eVTOL aircraft 100.

At block 406, the controller 212 and/or flight controller 120 may estimate the magnet strength of the permanent magnet 204 of the motor 200 based. The flux linkage may be used to determine the actual strength of the magnet(s) 204 of the motor 200, such as based on knowledge of the initial strength of the magnet(s) of the motor. For example, in some cases, it may be assumed that the strength of the permanent magnet 204 (e.g., in units of Amps/meter, Tesla, Gauss, etc.) changes as a function of the change in the flux linkage as the permanent magnet degrades. As a non-limiting example, it may be assumed that the permanent magnet strength degrades by the same percentage as the measured degradation in the flux linkage from when the motor 200 was new.

At block 408, the controller 212 and/or flight controller 120 may compare the flux linkage value to a corresponding threshold value to determine if the motor is healthy. The current flux linkage value may also be compared to the corresponding threshold value to determine if the magnet strength has weakened to a point where there is a safety concern. For example, a flux linkage of a motor 200, when new (e.g., prior to substantive loss of magnetization) may be 0.5 Wb. It may further be determined that a flux linkage value less than 0.4 Wb may present a safety concern. In this example, the measured flux linkage of the motor 200 may be compared to 0.4 Wb (the threshold value) and if the current flux linkage value of the motor is less than 0.4 Wb, then an unsafe operating condition may be identified. At this point, the controller 212 and/or controller 120 may display, such as on the display device 226, that the motor may be unsafe to use, in need of servicing, and/or require replacement.

At block 410, the controller 212 and/or flight controller 120 may provide an indication of motor health. A time series trend of the flux linkage may be used to estimate, such as by extrapolation, the remaining usable lifetime of the motor and/or its constituent magnet(s). For example, the current slope of the time series of the flux linkage measurements of the motor 200 may be extrapolated to identify when the current flux linkage of the motor 200 may intersect a corresponding threshold level. Such projections may inform maintenance schedules and/or safety inspections of the eVTOL aircraft 100.

Indicating the motor health may also involve off-aircraft logging of motor health data. For example, motor health data may be managed off-aircraft, by a server that records and tracks motor health for a fleet of aircraft 100. The flight controller 120 and/or motor controller 212 may send information about the motor health, such as all or a limited set of flux linkage and/or magnet strength values, of an eVTOL aircraft 100. This data may be logged by the fleet management server. Similarly, the magnet health data form other aircrafts 100 in the fleet may also be logged at the fleet management server. The fleet management server may mange the fleet according to the motor health of aircrafts 100 within the fleet. For example, the fleet management server may use any variety of statistical tools to examine the aggregate usage, degradation rates, lifetimes etc. of motors of aircraft 100 in the fleet. In some cases, the logging and analysis of fleetwide motor health may inform the deployment of equipment. For example, eVTOL aircraft 100 on routes that have a faster degradation (e.g., operating in hot climates, in greater turbulence conditions, etc.) of motors 200 may be swapped with e VTOL aircraft 100 that operate on routes that have slower degradation of motors 200. This way, the wear and tear on the motors 200 can, at least partially, be equilibrated across the fleet.

It should be understood that any suitable statistical techniques may be applied to any of the optional operations of method 400. For example, any of the operations of blocks 404-410 may be performed using smoothing techniques to manage any spurious flux linkage data. For example, any suitable window-sized moving average of flux linkage or magnet strength may be used for any of the aforementioned analysis. Furthermore, other statistical techniques, such as determining the mean and/or standard deviation of the flux linkage values, may be used to report flux linkage metrics for one or more motor(s) 200 and/or their corresponding permanent magnet(s) 204.

It should be noted that some of the operations of method 400 may be performed out of the order presented, with additional elements, and/or without some elements. Some of the operations of method 400 may further take place substantially concurrently and, therefore, may conclude in an order different from the order of operations shown above.

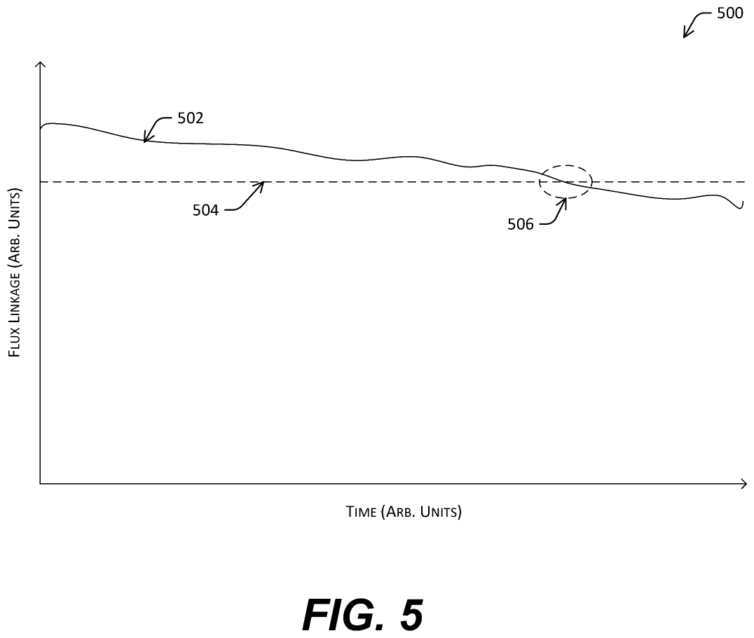

FIG. 5 is an example chart 500 depicting the monitoring of the flux linkage 502 of a motor 200 of the eVTOL aircraft 100 of FIG. 1 over time, according to examples of the disclosure. Also shown on this chart 500 is the flux linkage threshold value 504, below which the motor 200 health, and particularly the strength of the permanent magnet(s) 204, may be of concern. At point 506, the measured flux linkage of the motor 200 crosses below the corresponding threshold value. At this point, the controller 212 and/or flight controller 120 may provide an indication that the motor 200 may be unsafe for further use, such as on the display device 226.

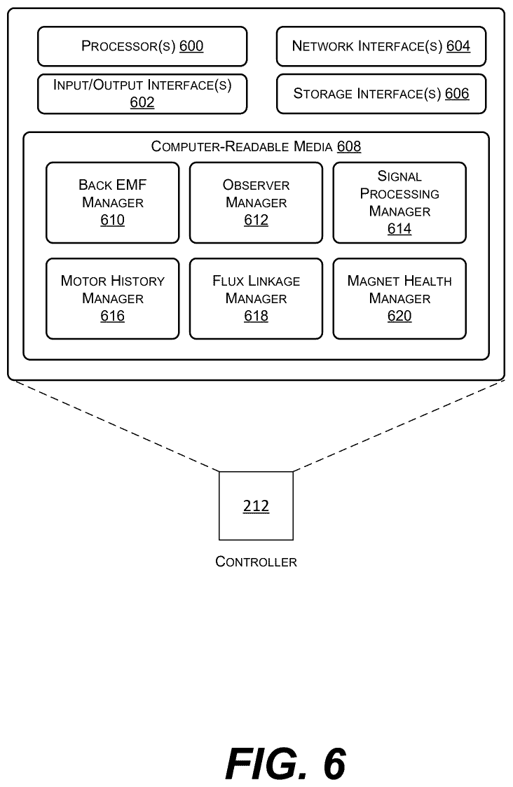

FIG. 6 is a block diagram of the controller 212 of the inverter of FIG. 2, according to examples of the disclosure. The controller 212 includes one or more processor(s) 600, one or more input/output (I/O) interface(s) 602, one or more communication interface(s) 604, one or more storage interface(s) 606, and computer-readable media 608. In examples, the processor(s) 600, I/O interfaces 602, communications interface(s) 604, storage interface(s) 606, and/or computer-readable media 608 may be part of an electronic device or computer system.

In some implementations, the processors(s) 600 may include a central processing unit (CPU), a graphics processing unit (GPU), both CPU and GPU, a microprocessor, a digital signal processor or other processing units or components known in the art. Alternatively, or in addition, the functionally described herein can be performed, at least in part, by one or more hardware logic components. For example, and without limitation, illustrative types of hardware logic components that may be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, each of the processor(s) 600 may possess its own local memory, which also may store program modules, program data, and/or one or more operating systems. The one or more processor(s) 600 may include one or more cores.

The one or more input/output (I/O) interface(s) 602 may enable the controller 212 to detect interaction with a human operator. For example, the operator may provide task instructions (e.g., intended flight maneuvers) or monitor metrics (e.g., motor speed, motor torque, etc.) from the inverter 206. The I/O interface may also enable interaction with human-machine interfaces (HMI), such as display device 226.

The network interface(s) 604 may enable the controller 212 to communicate via the one or more network(s). The network interface(s) 604 may include a combination of hardware, software, and/or firmware and may include software drivers for enabling any variety of protocol-based communications, and any variety of wireline and/or wireless ports/antennas. For example, the network interface(s) 604 may comprise one or more of WiFi, cellular radio, a wireless (e.g., IEEE 802.1x-based) interface, a Bluetooth® interface, and the like.

The storage interface(s) 606 may enable the processor(s) 600 to interface and exchange data with the computer-readable media 608, as well as any storage device(s) external to the controller 212. The storage interface(s) 606 may further enable access to removable media or datastores, such as the magnet health datastore 228.

The computer-readable media 608 may include volatile and/or nonvolatile memory, removable and non-removable media implemented in any method or technology for storage of information, such as computer-readable instructions, data structures, program modules, or other data. Such memory includes, but is not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, RAID storage systems, or any other medium which can be used to store the desired information and which can be accessed by a computing device. The computer-readable media 608 may be implemented as computer-readable storage media (CRSM), which may be any available physical media accessible by the processor(s) 600 to execute instructions stored on the computer readable media 608. In one basic implementation, CRSM may include random access memory (RAM) and Flash memory. In other implementations, CRSM may include, but is not limited to, read-only memory (ROM), electrically erasable programmable read-only memory

(EEPROM), or any other tangible media which can be used to store the desired information, and which can be accessed by the processor(s) 600. The computer-readable media 608 may have an operating system (OS) and/or a variety of suitable applications stored thereon. The OS, when executed by the processor(s) 600 may enable management of hardware and/or software resources of the controller 212.

Several components such as instruction, data stores, and so forth may be stored within the computer-readable media 608 and configured to execute on the processor(s) 600. The computer readable media 608 may have stored thereon a back EMF manager 610, an observer manager 612, a signal processing manager 614, a motor history manager 616, a flux linkage manager 618, and a magnet health manager 620. It will be appreciated that each of the components 610, 612, 614, 616, 618, 620 may have instructions stored thereon that when executed by the processor(s) 600 may enable various functions pertaining to operating the controller 212, as described herein.

The instructions stored in the back EMF manager 610, when executed by the processor(s) 600, may configure the controller 212 to monitor back EMF for the purposes of closed loop motor control. The controller 212 may use back EMF to track the position of the motor 200 to provide current control 214 to the MOSFETs 210, which in turn provides commutation signals the motor 200. The instructions stored in the observer manager 612, when executed by the processor(s) 600, may configure the controller 212 to observe the back EMF, as measured while the motor 200 spins. Thus, the controller 212 is able to use the back EMF measurements to enable feedback control.

The instructions stored in the signal processing manager 614, when executed by the processor(s) 600, may configure the controller 212 to process current and/or voltage data as received from current sensor(s) 208 and/or voltage sensor(s) 208. The signals, as received, may be processed and interpreted by the controller 212 to control the motor 200. Additionally, signals may be received from the flight controller 120, by the inverter controller 212, for control of the motor 200.

The instructions stored in the motor history manager 616, when executed by the processor(s) 600, may configure the controller 212 to store current flux linkage and/or magnet strength values of one or more motor(s) 200, such as in the motor health datastore 228. The instructions stored in the motor history manager 616, when executed by the processor(s) 600, may further configure the controller 212 to access historic flux linkage and/or magnet strength values of one or more motor(s) 200, such as in the motor health datastore 228.

The instructions stored in the flux linkage manager 618, when executed by the processor(s) 600, may configure the controller 212 to perform the operations of determining the current flux linkage of the motor 200. The controller 212 may use its back-EMF observer 218 function, along with the flux linkage measurement 220 function to determine the flux linkage of the motor 200. In some cases, the controller 212 may determine the magnitude and velocity of the back-EMF of the motor 200 to determine the flux linkage of the motor 200, such as by using Equation 1.

The instructions stored in the magnet health manager 620, when executed by the processor(s) 600, may configure the controller 212 to perform the operations of determining the permanent magnet 204 strength and/or health. The controller 212, individually or in conjunction with flight controller 120, may be configured to determine whether the flux linkage of the motor 200 is below a threshold level that indicates that the motor 200 is to be serviced and/or replaced.

The disclosure is described above with reference to block and flow diagrams of systems, methods, apparatuses, and/or computer program products according to the disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented or may not necessarily need to be performed at all, according to some examples of the disclosure.

Computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, the disclosure may provide for a computer program product, comprising a computer usable medium having a computer readable program code or program instructions embodied therein, said computer readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

It will be appreciated that each of the memories and data storage devices described herein can store data and information for subsequent retrieval. The memories and databases can be in communication with each other and/or other databases, such as a centralized database, or other types of data storage devices. When needed, data or information stored in a memory or database may be transmitted to a centralized database capable of receiving data, information, or data records from more than one database or other data storage devices. In other cases, the databases shown can be integrated or distributed into any number of databases or other data storage devices.

### EXAMPLE CLAUSES

While the example clauses described below are described with respect to one particular implementation, it should be understood that, in the context of this document, the content of the example clauses can also be implemented via a method, device, system, computer-readable medium, and/or another implementation. Additionally, any of examples A-T may be implemented alone or in combination with any other one or more of the examples A-T.
Clause A: In an aspect of the present disclosure, a motor controller includes one or more processors and one or more computer-readable media storing computer-executable instructions that, when executed by the one or more processors, cause the motor controller to determine a first current associated with a motor controlled by the motor controller. The computer-executable instructions, when executed by the one or more processors, cause the motor controller to determine, based at least in part on the first current, a back-electromotive force (EMF) signal associated with the motor, determine, based at least in part on the back-EMF signal, a back-EMF magnitude and a back-EMF velocity, determine, based at least in part on the back-EMF magnitude and the back-EMF velocity, a first flux linkage value of the motor at a first time, and cause to report the first flux linkage value.
Clause B: The motor controller is further configured to store the first flux linkage value, associated with the first time, in a datastore.
Clause C: The motor controller is further configured to receive, from the datastore, a second flux linkage value corresponding to a second time different from the first time and display, on the display device and based at least in part on a first flux linkage value and the second flux linkage value, a time series of flux linkage values.
Clause D: The motor controller is further configured to determine that the first flux linkage value is less than a threshold value, determine, based at least in part on the first flux linkage value being less than the threshold value, that the motor is unsafe to use, and indicate, on the display device, that the motor is unsafe to use.
Clause E: The motor controller is further configured to determine, based at least in part on the first flux linkage value and an initial permanent magnet strength, an estimate of a permanent magnet strength associated with the motor and display, on the display device, the estimate of the permanent magnet strength.
Clause F: The motor controller is further configured to determine that the motor is spinning at less than a threshold speed, operate, based at least in part on the motor spinning at less than the threshold speed, the motor in open loop operation by providing open loop commutation signals to the motor, and prior to determining the first current, stop providing the open loop commutation signals to the motor
Clause G: The motor controller is further configured to determine that the motor is spinning at greater than a threshold speed, wherein determining the first current is based at least in part on the motor spinning at greater than the threshold speed.
Clause H: In another aspect of the present disclosure, a method includes determining, by a motor controller using one or more current sensors, a first current associated with a motor controlled by the motor controller, determining, by the motor controller using the one or more current sensors, a second current associated with the motor, and determining, based at least in part on the first current and second current, a back-electromotive force (EMF) signal associated with the motor. The method further includes determining, based at least in part on the back-EMF signal, a first flux linkage value of the motor at a first time and causing to store, in a datastore, the first flux linkage value associated with the first time.
Clause I: The method includes determining, based at least in part on the back-EMF signal, a back-EMF magnitude and a back-EMF velocity, wherein the first flux linkage value is determined as the back-EMF magnitude divided by the back-EMF velocity.
Clause J: The method includes determining, by the motor controller using the one or more current sensors, a third current associated with the motor controlled by the motor controller, determining, based at least in part on the third current, a second back-EMF signal associated with the motor, determining, based at least in part on the second back-EMF signal, a second flux linkage value of the motor at a second time different from the first time, and causing to display, on a display device, the second flux linkage value.
Clause K: The method includes determining, based at least in part on the first flux linkage value and the second flux linkage value, a prediction of when the motor will need to be serviced.
Clause L: The method includes estimating, based at least in part on the first flux linkage value and an initial magnet strength value, a strength of a permanent magnet of the motor.
Clause M: The method includes determining that the first flux linkage value is less than a threshold value, determining, based at least in part on the first flux linkage value being less than the threshold value, that the motor is unsafe to use, and indicating, on a display device, that the motor is unsafe to use.
Clause N: The method includes determining that the motor is spinning at less than a threshold speed, operating, based at least in part on the motor spinning at less than the threshold speed, the motor in open loop operation by providing open loop commutation signals to the motor, and prior to determining the first current, stopping providing the open loop commutation signals to the motor.
Clause O: In yet another aspect of the present disclosure, an aircraft includes one or more controller(s), a datastore, a motor, one or more current sensors communicatively coupled to the one or more controller(s), and a display device. The one or more controller(s) are configured to receive, from the one or more current sensors, a current value associated with the motor, determine, based at least in part on the current value, a back-electromotive force (EMF) value associated with the motor, and determine, based at least in part on the back-EMF value, a flux linkage value at a first time. The one or more controller(s) are configured to determine that the flux linkage value is greater than a threshold level, determine, based at least in part on the flux linkage value being greater than the threshold level, that the motor is safe to use, indicate, on the display device, that the motor is safe to use, and store the flux linkage value in association with the first time in the datastore.
Clause P: The aircraft, where the one or more controller(s) are configured to determine, based at least in part on the back-EMF value, a back-EMF magnitude and a back-EMF velocity, wherein the flux linkage value is determined as the back-EMF magnitude divided by the back-EMF velocity.
Clause Q: The aircraft, where the aircraft includes an electric vertical take-off and landing (eVTOL) aircraft.
Clause R: The aircraft includes a second motor and one or more second current sensors communicatively coupled to the one or more controller(s), wherein the one or more controller(s) are configured to receive, from the one or more second current sensors, a second current value associated with the second motor and determine, based at least in part on the second current value, a second back-EMF value associated with the second motor. The one or more controller(s) are further configured to determine, based at least in part on the second back-EMF value, a second flux linkage value at a second time, determine that the second flux linkage value is less than the threshold level, determine, based at least in part on the second flux linkage value being less than the threshold level, that the second motor is unsafe to use, and indicate, on the display device, that the second motor is unsafe to use.
Clause S: The aircraft, where the one or more controller(s) are configured to store the second flux linkage value in association with the second time and the second motor in the datastore.
Clause T: The aircraft, where the one or more controller(s) are configured to determine that the motor is spinning at less than a threshold speed, operate, based at least in part on the motor spinning at less than the threshold speed, the motor in open loop operation by providing open loop commutation signals to the motor, and prior to determining the current value, stop providing the open loop commutation signals to the motor.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein.

What is claimed is:

1. A motor controller, comprising:
one or more processors;
one or more computer-readable media storing computer-executable instructions that, when executed by the one or more processors, cause the motor controller to:
determine a first current associated with a motor controlled by the motor controller;
determine, based at least in part on the first current, a back-electromotive force (EMF) signal associated with the motor;
determine, based at least in part on the back-EMF signal, a back-EMF magnitude and a back-EMF velocity;
determine, based at least in part on the back-EMF magnitude and the back-EMF velocity, a first flux linkage value of the motor at a first time; and
cause to report the first flux linkage value.

2. The motor controller of claim 1, wherein the computer-executable instructions, when executed by the one or more processors, further cause the motor controller to:
store the first flux linkage value, associated with the first time, in a datastore.

3. The motor controller of claim 2, wherein the computer-executable instructions, when executed by the one or more processors, further cause the motor controller to:
receive, from the datastore, a second flux linkage value corresponding to a second time different from the first time; and
display, on the display device and based at least in part on a first flux linkage value and the second flux linkage value, a time series of flux linkage values.

4. The motor controller of claim 1, wherein the computer-executable instructions, when executed by the one or more processors, further cause the motor controller to:
determine that the first flux linkage value is less than a threshold value;
determine, based at least in part on the first flux linkage value being less than the threshold value, that the motor is unsafe to use; and
indicate, on the display device, that the motor is unsafe to use.

5. The motor controller of claim 1, wherein the computer-executable instructions, when executed by the one or more processors, further cause the motor controller to:
determine, based at least in part on the first flux linkage value and an initial permanent magnet strength, an estimate of a permanent magnet strength associated with the motor; and
display, on the display device, the estimate of the permanent magnet strength.

6. The motor controller of claim 1, wherein the computer-executable instructions, when executed by the one or more processors, further cause the motor controller to:
determine that the motor is spinning at less than a threshold speed;
operate, based at least in part on the motor spinning at less than the threshold speed, the motor in open loop operation by providing open loop commutation signals to the motor; and
prior to determining the first current, stop providing the open loop commutation signals to the motor.

7. The motor controller of claim 1, wherein the computer-executable instructions, when executed by the one or more processors, further cause the motor controller to:
determine that the motor is spinning at greater than a threshold speed, wherein determining the first current is based at least in part on the motor spinning at greater than the threshold speed.

8. A method, comprising:
determining, by a motor controller using one or more current sensors, a first current associated with a motor controlled by the motor controller;
determining, by the motor controller using the one or more current sensors, a second current associated with the motor;
determining, based at least in part on the first current and second current, a back-electromotive force (EMF) signal associated with the motor;
determining, based at least in part on the back-EMF signal, a first flux linkage value of the motor at a first time; and
causing to store, in a datastore, the first flux linkage value associated with the first time.

9. The method of claim 8, further comprising:
determining, based at least in part on the back-EMF signal, a back-EMF magnitude and a back-EMF velocity, wherein the first flux linkage value is determined as the back-EMF magnitude divided by the back-EMF velocity.

10. The method of claim 8, further comprising:
determining, by the motor controller using the one or more current sensors, a third current associated with the motor controlled by the motor controller;
determining, based at least in part on the third current, a second back-EMF signal associated with the motor;
determining, based at least in part on the second back-EMF signal, a second flux linkage value of the motor at a second time different from the first time; and
causing to display, on a display device, the second flux linkage value.

11. The method of claim 10, further comprising:
determining, based at least in part on the first flux linkage value and the second flux linkage value, a prediction of when the motor will need to be serviced.

12. The method of claim 8, further comprising:
estimating, based at least in part on the first flux linkage value and an initial magnet strength value, a strength of a permanent magnet of the motor.

13. The method of claim 8, further comprising:
determining that the first flux linkage value is less than a threshold value;
determining, based at least in part on the first flux linkage value being less than the threshold value, that the motor is unsafe to use; and
indicating, on a display device, that the motor is unsafe to use.

14. The method of claim 8, further comprising:
determining that the motor is spinning at less than a threshold speed;
operating, based at least in part on the motor spinning at less than the threshold speed, the motor in open loop operation by providing open loop commutation signals to the motor; and
prior to determining the first current, stopping providing the open loop commutation signals to the motor.

15. An aircraft comprising:
one or more controller(s);
a datastore;
a motor;
one or more current sensors communicatively coupled to the one or more controller(s); and
a display device, wherein the one or more controller(s) are configured to:
receive, from the one or more current sensors, a current value associated with the motor;
determine, based at least in part on the current value, a back-electromotive force (EMF) value associated with the motor;
determine, based at least in part on the back-EMF value, a flux linkage value at a first time;
determine that the flux linkage value is greater than a threshold level;
determine, based at least in part on the flux linkage value being greater than the threshold level, that the motor is safe to use;
indicate, on the display device, that the motor is safe to use; and
store the flux linkage value in association with the first time in the datastore.

16. The aircraft of claim 15, wherein the one or more controller(s) are configured to:
determine, based at least in part on the back-EMF value, a back-EMF magnitude and a back-EMF velocity, wherein the flux linkage value is determined as the back-EMF magnitude divided by the back-EMF velocity.

17. The aircraft of claim 15, wherein the aircraft comprises an electric vertical take-off and landing (eVTOL) aircraft.

18. The aircraft of claim 15, further comprising:
a second motor; and
one or more second current sensors communicatively coupled to the one or more controller(s), wherein the one or more controller(s) are configured to:
receive, from the one or more second current sensors, a second current value associated with the second motor;
determine, based at least in part on the second current value, a second back-EMF value associated with the second motor;
determine, based at least in part on the second back-EMF value, a second flux linkage value at a second time;
determine that the second flux linkage value is less than the threshold level;
determine, based at least in part on the second flux linkage value being less than the threshold level, that the second motor is unsafe to use; and
indicate, on the display device, that the second motor is unsafe to use.

19. The aircraft of claim 18, wherein the one or more controller(s) are configured to:
store the second flux linkage value in association with the second time and the second motor in the datastore.

20. The aircraft of claim 15, wherein the one or more controller(s) are configured to:
determine that the motor is spinning at less than a threshold speed;
operate, based at least in part on the motor spinning at less than the threshold speed, the motor in open loop operation by providing open loop commutation signals to the motor; and
prior to determining the current value, stop providing the open loop commutation signals to the motor.
